(19) United States
(12) Patent Application Publication
(10) Pub. No.: US 2025/0131133 A1
(43) Pub. Date: Apr. 24, 2025

(54) METHODS AND SYSTEMS OF FACILITATING PROVISIONING OF A VERIFICATION DATA

(71) Applicant: Cleo Roberts, Portland, OR (US)

(72) Inventor: Cleo Roberts, Portland, OR (US)

(21) Appl. No.: 18/924,465

(22) Filed: Oct. 23, 2024

Related U.S. Application Data
(60) Provisional application No. 63/592,447, filed on Oct. 23, 2023.

(51) Int. Cl. G06F 21/64

(52) U.S. Cl. CPC G06F 21/64

(57) ABSTRACT

The present disclosure provides a method of facilitating provisioning of verification data. Further, the method may include receiving digital content data from one or more of a content provider device and a user device. Further, the method may include analyzing the digital content data. Further, the method may include identifying claimed data based on the analyzing. Further, the method may include generating a query based on the claimed data. Further, the method may include retrieving reference data. Further, the retrieving of the reference data may be based on the query. Further, the method may include analyzing the claimed data, and the reference data. Further, the method may include generating validity data based on the analyzing. Further, the validity data indicates an authenticity of the claimed data based on the reference data. Further, the association indicator represents an association between the validity data and the claimed data.

### RELATED APPLICATIONS

The instant patent application claims priority to the U.S. provisional patent application No. 63/592,447, titled “METHODS AND SYSTEMS FOR FACILITATING IDENTIFYING AND RATING CLAIMS ON A WEBPAGE BASED ON FACT CHECKS” filed on Oct. 23, 2023, the entirety of which is incorporated herein by reference.

### FIELD OF THE INVENTION

The present invention relates generally to data processing. More specifically, the present invention is methods and systems for facilitating provisioning of verification data.

### BACKGROUND OF THE INVENTION

The field of data processing is technologically important to several industries, business organizations, and/or individuals.

A huge quantity of information related to various topics is available on the internet which can be consumed using mobile devices, televisions, and many other outlets by the audience. Existing techniques for facilitating identifying and rating claims on a webpage based on fact checks are deficient with regard to several aspects. For instance, current technologies do not facilitate identifying claims on multiple webpages and provide ratings corresponding to the claim. Without the authenticity and credibility of the claims on the webpages, the audience is vulnerable to various personal and safety threats (such as health threats for health-related claims). Current technologies lack an efficient and fast way to provide the rating.

Therefore, there is a need for improved methods and systems for facilitating identifying and rating claims on a webpage based on fact checks that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating provisioning of verification data. Further, the method may include receiving, using a communication device, digital content data from one or more of a content provider device associated with a content provider and a user device. Further, the method may include analyzing, using a processing device, the digital content data. Further, the method may include identifying, using the processing device, a claimed data associated with the digital content data based on the analyzing. Further, the method may include generating, using the processing device, a query based on the claimed data. Further, the method may include retrieving, using a storage device, reference data. Further, the retrieving of the reference data may be based on the query. Further, the method may include analyzing, using the processing device, the claimed data, and the reference data. Further, the method may include generating, using the processing device, validity data based on the analyzing. Further, the validity data indicates an authenticity of the claimed data based on the reference data. Further, the method may include transmitting, using the communication device, the validity data, and an association indicator to one or more of the content provider device and the user device. Further, the association indicator represents an association between the validity data and the claimed data.

The present disclosure provides a system for facilitating provisioning of verification data. Further, the system may include a communication device. Further, the communication device may be configured to receive digital content data from one or more of a content provider device associated with a content provider and a user device. Further, the communication device may be configured to transmit validity data, and an association indicator to one or more of the content provider device and the user device. Further, the association indicator represents an association between the validity data and a claimed data. Further, the system may include a processing device communicatively coupled with the communication device. Further, the processing device may be configured to analyze the digital content data. Further, the processing device may be configured to identify the claimed data associated with the digital content data based on the analyzing. Further, the processing device may be configured to generate a query based on the claimed data. Further, the processing device may be configured to analyze the claimed data, and reference data. Further, the processing device may be configured to generate the validity data based on the analyzing. Further, the validity data indicates an authenticity of the claimed data based on the reference data. Further, the system may include a storage device communicatively coupled with each of the communication device and the processing device. Further, the storage device may be configured to retrieve the reference data. Further, the retrieving of the reference data may be based on the query.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 of facilitating provisioning of a verification data, in accordance with some embodiments.

FIG. 3B illustrates a continuation of the flowchart of the method 300 of facilitating provisioning of verification data, in accordance with some embodiments.

FIG. 4 illustrates a flowchart of a method 400 of facilitating provisioning of a verification data including generating, using the processing device 604, a user interface, in accordance with some embodiments.

FIG. 5 illustrates a flowchart of a method 500 of facilitating provisioning of a verification data including receiving, using the communication device 602, the reference data, in accordance with some embodiments.

FIG. 6 illustrates a block diagram of a system 600 of facilitating provisioning of a verification data, in accordance with some embodiments.

FIG. 7 is a block diagram of a system 700 for facilitating identifying and rating claims on a webpage based on fact checks, in accordance with some embodiments.

FIG. 8 is a flow chart of a method 800 for facilitating identifying and rating claims on a webpage based on fact checks, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g., a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer, etc.) and/or possession of a machine readable secret data (e.g., encryption key, decryption key, bar codes, etc.) and/or or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device, etc.) corresponding to the performance of the one or more steps, environmental variables (e.g., temperature, humidity, pressure, wind speed, lighting, sound, etc.) associated with a device corresponding to the performance of the one or more steps, physical state and/or physiological state and/or psychological state of the user, physical state (e.g., motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor, etc.), a biometric sensor (e.g., a fingerprint sensor), an environmental variable sensor (e.g., temperature sensor, humidity sensor, pressure sensor, etc.) and a device state sensor (e.g., a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

According to some embodiments, a system for facilitating identifying and rating claims on a webpage based on fact checks is disclosed. Accordingly, the system may include a communication device configured for receiving at least one webpage data associated with at least one webpage from at least one user device associated with at least one user. Further, the communication device may be configured for transmitting at least one claim information to at least one device. Further, the at least one device may include a server. Further, the at least one device may be configured for collecting at least one fact data associated with the at least one claim based on the at least one claim. Further, the communication device may be configured for receiving the at least one fact data from the at least one device. Further, the communication device may be configured for transmitting at least one of a rating, the at least one webpage data, and the at least one fact data to the at least one user device. Further, the system may include a processing device configured for analyzing the at least one webpage data. Further, in some embodiments, the analyzing of the at least one webpage data may include analyzing the at least one webpage data using at least one model. Further, in an instance, the at least one model may include at least one statistical model, at least one logical model, and at least one mathematical model. Further, in some embodiments, at least one of the at least one statistical model, the at least one logical model, and the at least one mathematical model may include at least one artificial intelligence model. Further, the at least one artificial intelligence model may include a machine learning model. Further, the machine learning model may include a natural language processing model, a decision tree, and so on.

Further, the processing device may be configured for identifying the at least one claim based on the analyzing. Further, the processing device may be configured for processing the at least one fact data and the at least one claim information. Further, in some embodiments, the processing of the at least one fact data and the at least one claim information may include processing of the at least one fact data and the at least one claim information using at least one second model, which may include at least one statistical model, at least one logical model, and at least one mathematical model. Further, in some embodiments, at least one of the at least one statistical model, the at least one logical model, and the at least one mathematical model may include at least one artificial intelligence model. Further, the processing device may be configured for generating the at least one rating corresponding to each of the at least one claim based on the processing. Further, the system may include a storage device configured for storing the at least one claim information, the at least one rating, the at least one fact data, and the at least one webpage data.

Further disclosed herein is a method for facilitating identifying and rating claims on a webpage based on fact checks, in accordance with some embodiments. Accordingly, the method may include receiving, using a communication device, at least one webpage data associated with at least one webpage from at least one user device associated with at least one user. Further, the method may include analyzing, using a processing device, the at least one webpage data. Further, the method may include identifying, using the processing device, at least one claim based on the analyzing. Further, the method may include transmitting, using the communication device, the at least one claim information to at least one device. Further, the method may include receiving, using the communication device, the at least one fact data from the at least one device. Further, the method may include processing, using the processing device, the at least one fact data and the at least one claim information using at least one second artificial intelligence model. Further, the method may include generating, using the processing device, at least one rating corresponding to each of the at least one claim based on the processing. Further, the method may include transmitting, using the communication device, at least one of the at least one rating, the at least one webpage data, and the at least one fact data to the at least one user device. Further, the method may include storing, using a storage device, the at least one claim information, the at least one rating, the at least one fact data, and the at least one webpage data.

The present disclosure describes methods and systems for facilitating identifying and rating claims on a webpage based on fact checks. Further, the disclosed system may be configured to identify the claims on the webpages and display fact checks of those claims and associated ratings to consumers alongside the webpages.

Further, on the back end, the disclosed system may include a software platform (such as a website, a software application, etc.) intended to identify similar claims on multiple webpages and collect fact checks. Further, in some embodiments, the disclosed system may be based on an algorithm to assign ratings. Further, in some embodiments, the disclosed system may not be based on an algorithm to assign the ratings. On the front end, the disclosed system may include a second software platform (such as a website, a software application, etc.) to display the webpages, the fact checks, and the ratings simultaneously.

Further, the functions of the disclosed system may include a front end that may be performed using a software invention.

The present disclosure describes a method of facilitating identifying and rating claims on a webpage based on fact checks, in accordance with some embodiments. Accordingly, the method may include a claim identifier identifying claims in a webpage. Further, the method may allow the claim identifier to check the validity of a claim. Further, the method may include storing the claim and at least one associated fact in a local browser storage.

Further, the method may include creating highlights for the consumer to see. Further, upon the consumer hovering a cursor over a created highlight, the method may include a visualization of the fact-checked note for the highlight.

Further, the disclosed system may include a program to identify claims in web pages (or a plurality of web pages). Further, the claims may be associated with information. Further, the system may include a program to enter fact checks of the claims. Further, the system may be based on an algorithm configured to create a rating of the web pages. Further, the system may be communicatively coupled with a company database. Further, the system may be associated with a software for visualizing the fact checks. Further, the system may be communicatively coupled with a user device.

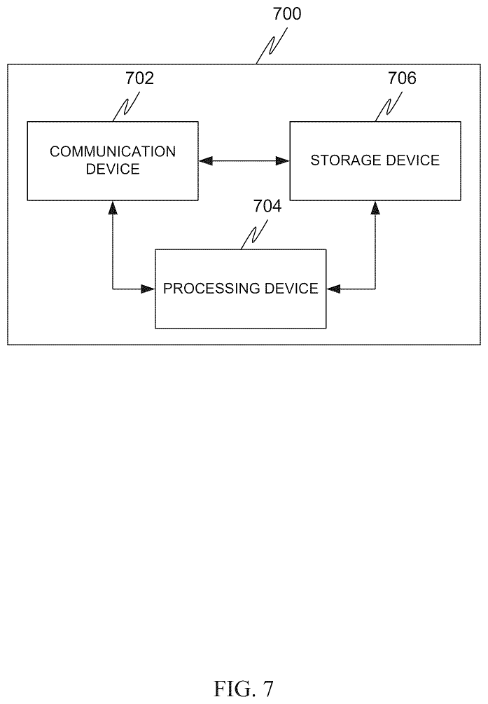

FIG. 7 is a block diagram of a system 700 for facilitating identifying and rating claims on a webpage based on fact checks, in accordance with some embodiments. Accordingly, the system 700 may include a communication device 702 configured for receiving at least one webpage data associated with at least one webpage from at least one user device associated with at least one user. Further, the at least one user device may include a smartphone, a tablet, a mobile, a laptop, etc. Further, the at least one user may include an individual, an institution, and an organization. Further, the at least one webpage data may include a textual content, a graphical content, etc. Further, the graphical content may include an image, a video, an audio-video, etc. Further, the communication device 702 may be configured for transmitting at least one claim information to at least one device. Further, the at least one device may include a server. Further, the at least one device may be configured for collecting at least one fact data associated with the at least one claim based on the at least one claim. Further, the communication device 702 may be configured for receiving the at least one fact data from the at least one device. Further, the communication device 702 may be configured for transmitting at least one of a rating, the at least one webpage data, and the at least one fact data to the at least one user device.

Further, the system 700 may include a processing device 704 configured for analyzing the at least one webpage data. Further, in some embodiments, the analyzing of the at least one webpage data may include analyzing the at least one webpage data using at least one model. Further, in an instance, the at least one model may include at least one statistical model, at least one logical model, and at least one mathematical model. Further, in some embodiments, at least one of the at least one statistical model, the at least one logical model, and the at least one mathematical model may include at least one artificial intelligence model. Further, the at least one artificial intelligence model may include a machine learning model. Further, the machine learning model may include a natural language processing model, a decision tree, and so on. Further, the processing device 704 may be configured for identifying the at least one claim based on the analyzing. Further, the at least one claim may be associated with at least one claim information. Further, the processing device 704 may be configured for processing the at least one fact data and the at least one claim information. Further, in some embodiments, the processing of the at least one fact data and the at least one claim information may include processing the at least one fact data and the at least one claim information using at least one second model, which may include at least one statistical model, at least one logical model, and at least one mathematical model. Further, in some embodiments, at least one of the at least one statistical model, the at least one logical model, and the at least one mathematical model may include at least one artificial intelligence model. Further, the processing device 704 may be configured for generating the at least one rating corresponding to each of the at least one claim based on the processing.

Further, the system 700 may include a storage device 706 configured for storing the at least one claim information, the at least one rating, the at least one fact data, and the at least one webpage data.

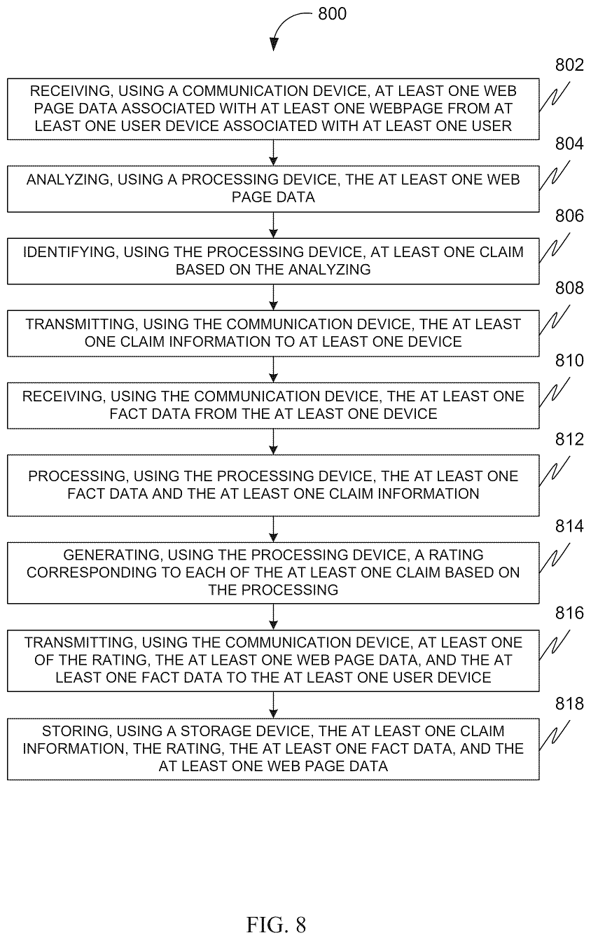

FIG. 8 is a flow chart of a method for facilitating identifying and rating claims on a webpage based on fact checks, in accordance with some embodiments. Accordingly, the method may include a step 802 of receiving, using a communication device 702, at least one webpage data associated with at least one webpage from at least one user device associated with at least one user. Further, the at least one user device may include a smartphone, a tablet, a mobile device, a laptop, etc. Further, the at least one user may include an individual, an institution, and an organization. Further, the at least one webpage data may include a textual content, a graphical content, etc. Further, the graphical content may include an image, a video, an audio-video, etc.

Further, the method may include a step 804 of analyzing, using a processing device 704, the at least one webpage data. Further, in some embodiments, the analyzing of the at least one webpage data may include analyzing the at least one webpage data using at least one model. Further, in an instance, the at least one model may include at least one statistical model, at least one logical model, and at least one mathematical model. Further, in some embodiments, at least one of the at least one statistical model, the at least one logical model, and the at least one mathematical model may include at least one artificial intelligence model. Further, the at least one artificial intelligence model may include a machine learning model. Further, the machine learning model may include a natural language processing model, a decision tree, and so on.

Further, the method may include a step 806 of identifying, using the processing device 704, at least one claim based on the analyzing. Further, the at least one claim may be associated with at least one claim information.

Further, the method may include a step 808 of transmitting, using the communication device 702, the at least one claim information to at least one device. Further, the at least one device may include a server. Further, the at least one device may be configured for collecting at least one fact data associated with the at least one claim based on the at least one claim. Further, the collecting of the at least one fact may include collecting the at least one fact from a plurality of sources. Further, the plurality of sources may include a plurality of media, which may include a plurality of webpages, books, journals, magazines, photographs, videos, official reports, and/or other documents associated with trusted sources. Further, the trusted sources may be associated with a research organization, a government organization, and so on.

Further, the method may include a step 810 of receiving, using the communication device 702, the at least one fact data from the at least one device. Further, the at least one fact data may include an image, an audio, an audio-video, a video, a textual content, etc. Further, in an instance, the at least corresponds to any device (such as a web server, a user device such as a smartphone, etc.) from which the at least one fact data present in one or more webpages for fact checking is received.

Further, the method may include a step 812 of processing, using the processing device 704, the at least one fact data, and the at least one claim information. Further, in some embodiments, the processing of the at least one fact data and the at least one claim information may include processing the at least one fact data and the at least one claim information using at least one second model, which may include at least one statistical model, at least one logical model, and at least one mathematical model. Further, in some embodiments, at least one of the at least one statistical model, the at least one logical model, and the at least one mathematical model may include at least one artificial intelligence model.

Further, the method may include a step 814 of generating, using the processing device 704, at least one rating corresponding to each of the at least one claim based on the processing.

Further, the method may include a step 816 of transmitting, using the communication device 702, at least one of the at least one rating, the at least one webpage data, and the at least one fact data to the at least one user device.

Further, the method may include a step 818 of storing, using a storage device 706, the at least one claim information, the at least one rating, the at least one fact data, and the at least one webpage data.

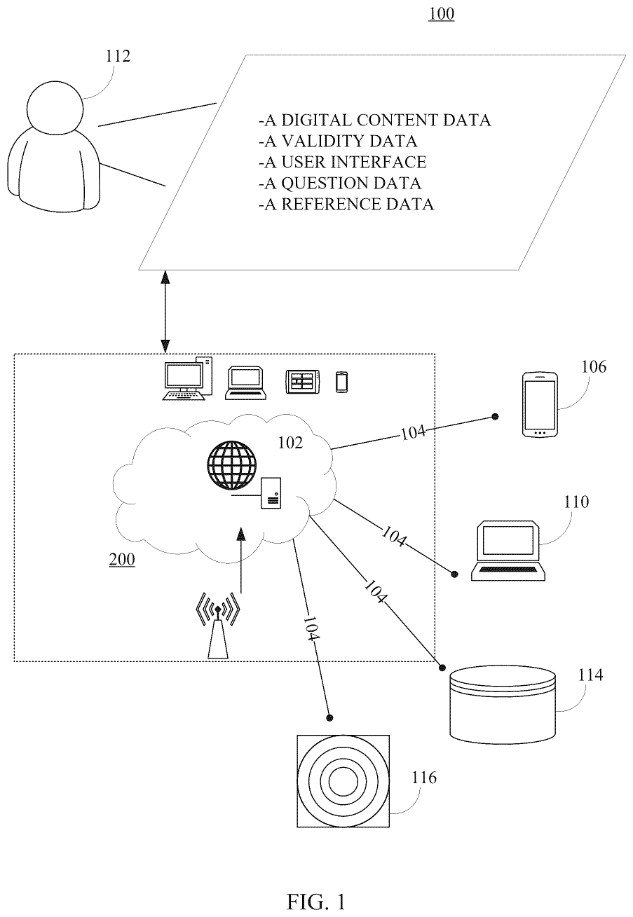

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 200.

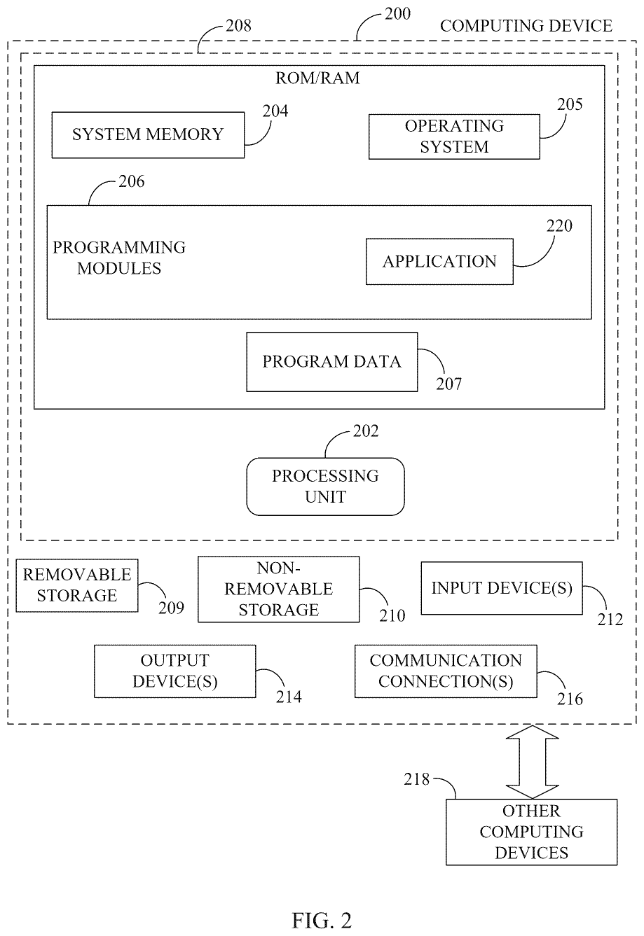

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include operating system 205, one or more programming modules 206, and may include program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable, and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include but is not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

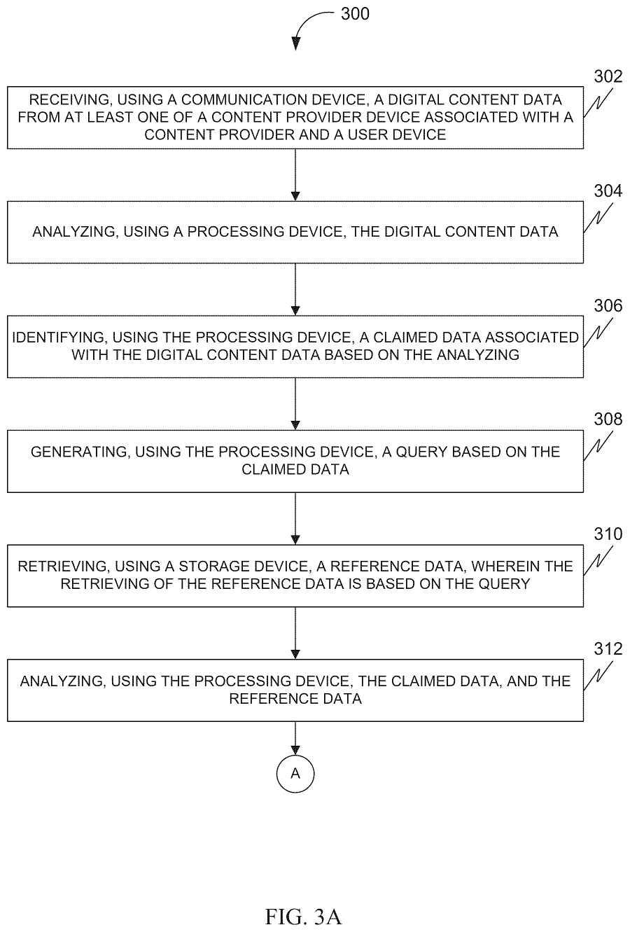

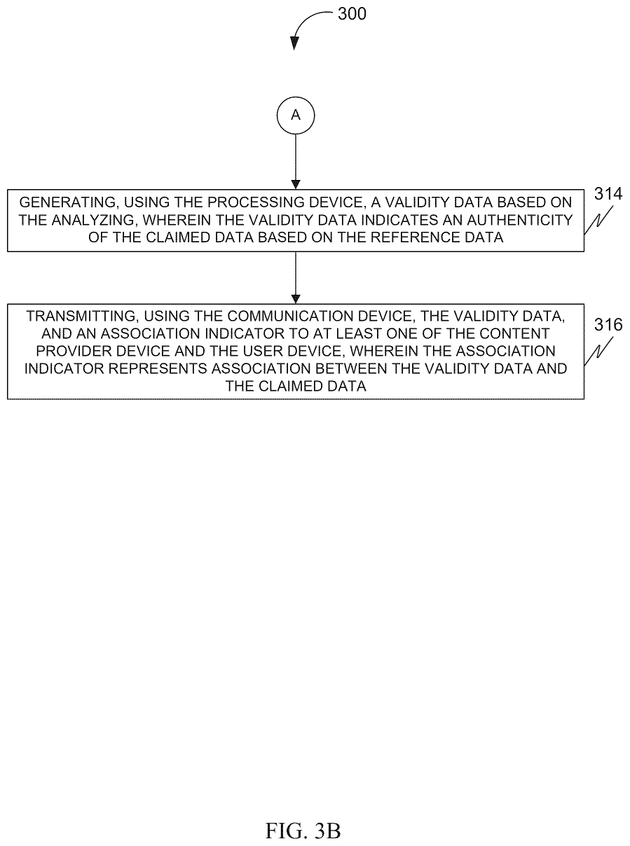

FIG. 3A and FIG. 3B illustrate a flowchart of a method 300 of facilitating provisioning of a verification data, in accordance with some embodiments.

Accordingly, the method 300 may include a step 302 of receiving, using a communication device 602, a digital content data from one or more of a content provider device associated with a content provider and a user device.

In some embodiments, the digital content data includes one or more of a textual data, a visual data, and an audio data. In some embodiments, the digital content data includes a webpage data. Further, the content provider includes a website. In some embodiments, the content provider device includes one or more of a smartphone, a smart device, a computing device, and a server. In some embodiments, the user device includes one or more of a smartphone, a smart device, and a computing device. In some embodiments, the communication device 602 may be an electronic device which may be configured to one or more of receive or transmit a data. In some embodiments, one or more of receiving and transmitting of the data may be wireless.

Further, the method 300 may include a step 304 of analyzing, using a processing device 604, the digital content data.

In some embodiments, the processing device 604 includes an electronic device which may be configured to execute a set of instructions.

In some embodiments, the analyzing of the digital content data may be based on a first model. In some embodiments, the first model includes one or more of a statistical model, a logical model, a mathematical model, and an artificial intelligence model. In some embodiments, the artificial intelligence model includes a machine learning model. In some embodiments, the machine learning model includes one or more of a supervised learning model, an unsupervised learning model, a semi supervised learning model, and a reinforcement learning model.

Further, the method 300 may include a step 306 of identifying, using the processing device 604, a claimed data associated with the digital content data based on the analyzing.

In some embodiments, the claimed data corresponds to a statement present in the digital content data.

Further, the method 300 may include a step 308 of generating, using the processing device 604, a query based on the claimed data.

In some embodiments, the query corresponds to a keyword associated with the claimed data.

Further, the method 300 may include a step 310 of retrieving, using a storage device 606, a reference data. Further, the retrieving of the reference data may be based on the query.

In some embodiments, the storage device 606 includes one or more of a volatile memory and a non-volatile memory. In some embodiments, the storage device 606 includes a database.

Further, the method 300 may include a step 312 of analyzing, using the processing device 604, the claimed data, and the reference data.

In some embodiments, the analyzing of the claimed data and the reference data may be based on a second model. In some embodiments, the second model includes one or more of a statistical model, a logical model, a mathematical model, and an artificial intelligence model.

Further, the method 300 may include a step 314 of generating, using the processing device 604, a validity data based on the analyzing. Further, the validity data indicates an authenticity of the claimed data based on the reference data.

In some embodiments, the validity data includes one or more of a numerical value, a textual data, and an accuracy rating. In some embodiments, the authenticity includes a factual accuracy of the claimed data. In some embodiments, the reference data includes a factual data received from a credible source. In some embodiments, the credible source includes one or more of a government website, a regulated entity, and a credible media source.

Further, the method 300 may include a step 316 of transmitting, using the communication device 602, the validity data, and an association indicator to one or more of the content provider device and the user device. Further, the association indicator represents an association between the validity data and the claimed data.

In some embodiments, the analyzing of the digital content data may be based on a first machine learning model. In some embodiments, the first machine learning model includes a neural network.

Further, the first machine learning model may be trained on a natural language processing algorithm. Further, the first machine learning model may be configured to receive the digital content data as input. Further, the first machine learning model may be configured to recognize a pattern associated with the digital content data based on the training. Further, the first machine learning model may be configured to identify the claimed data based on recognizing of the pattern.

In some embodiments, the reference data may be stored in a hierarchical data structure comprising of two or more reference data. Further, each of the two or more reference data includes index data which may be configured to allow accessing of a corresponding reference data within the hierarchical data structure.

In some embodiments, the digital content data includes a visual data. Further, the analyzing of the digital content data may be based on an image processing model. Further, the method 300 further includes generating, using the processing device 604, a text data based on the analyzing. Further, the identification of the claimed data may be further based on the text data.

In some embodiments, the digital content data includes audio data. Further, the analyzing of the digital content data may be based on an audio processing model. Further, the method 300 further includes generating, using the processing device 604, an audio extracted data based on the analyzing. Further, the identification of the claimed data may be further based on the audio extracted data.

In some embodiments, the analyzing of the claimed data and the reference data may be based on a second machine learning model. Further, the second machine learning model may be trained on a natural language processing algorithm. Further, the second machine learning model may be configured to receive the claimed data and the reference data as input. Further, the machine learning model may be configured to determine one or more of a similarity data, a dissimilarity data, a context data, and a verdict data. Further, the generation of the validity data may be based on the determination of the one or more of the similarity data, the dissimilarity data, the context data, and the verdict data.

In some embodiments, the reference data includes two or more reference data. Further, the method 300 further includes generating, using a processing device 604, two or more results. Further, each of the two or more results may be associated with a factual accuracy of the digital content data based on each of the two or more reference data. Further, the validity data may be generated based on the two or more initial fact checks.

In some embodiments, the validity data may be generated by calculating an average based on each of the two or more results.

In some embodiments, the method 300 may further include communicating, using the communication device 602, with the user device comprising of a user processing device, a user communication device, and a user device sensor. Further, the user device sensor may be configured to generate a sensor data. Further, the user communication device may be configured to transmit the digital content data based on the sensor data.

Further, in some embodiments, the method 300 further may include receiving, using the communication device 602, the reference data from a data provider. Further, the receiving may be based on identification of the claimed data.

In some embodiments, the data provider includes two or more media comprising two or more webpage, a book, a journal, a magazine, a photograph, a video, an official report, and documents associated with a trusted source. In some embodiments, the trusted source includes a research organization, a government organization, and a regulated organization.

Further, in some embodiments, the method 300 further may include storing, using a storage device 606, the reference data. Further, in some embodiments, the method 300 further may include generating, using the processing device 604, a search query based on the identification of the claimed data. Further, in some embodiments, the method 300 further may include transmitting, using the communication device 602, the search query to a data provider. Further, receiving of the reference data may be in response to the search query.

In some embodiments, the method 300 may further include transmitting, using the communication device 602, the reference data to one or more of the content provider device, and the user device. Further, one or more of the content provider device, and the user device may be configured to present the reference data and the validity data corresponding to the claimed data.

Further, in some embodiments, the method 300 further may include receiving, using the communication device 602, a claim indicator from one or more of content provider device and the user device. Further, in some embodiments, the method 300 further may include analyzing, using the processing device 604, the claim indicator. Further, the identification of the claimed data may be further based on the analyzing of the claim indicator.

In some embodiments, the method 300 may further include storing, using the storage device 606, the validity data.

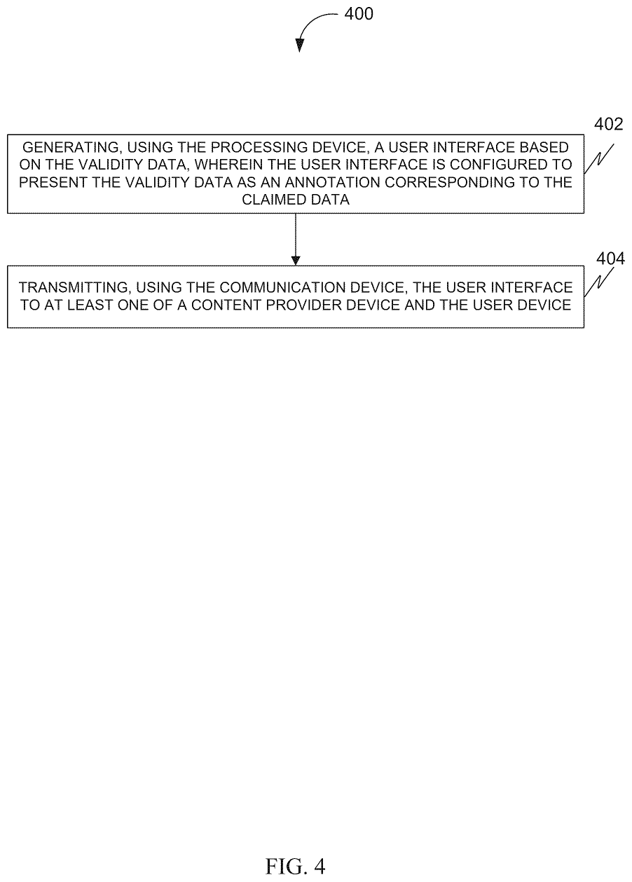

FIG. 4 illustrates a flowchart of a method 400 of facilitating provisioning of a verification data including generating, using the processing device 604, a user interface, in accordance with some embodiments.

Further, in some embodiments, the method 400 further may include a step 402 of generating, using the processing device 604, a user interface based on the validity data. Further, the user interface may be configured to present the validity data as an annotation corresponding to the claimed data. Further, in some embodiments, the method 400 further may include a step 404 of transmitting, using the communication device 602, the user interface to one or more of a content provider device and the user device.

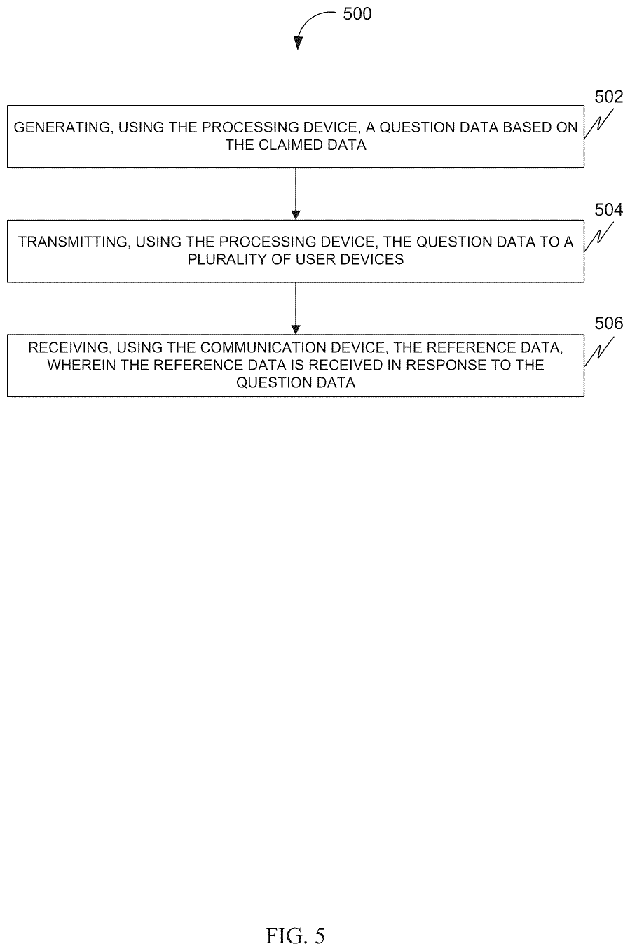

FIG. 5 illustrates a flowchart of a method 500 of facilitating provisioning of a verification data including receiving, using the communication device 602, the reference data, in accordance with some embodiments.

Further, in some embodiments, the method 500 further may include a step 502 of generating, using the processing device 604, a question data based on the claimed data. Further, in some embodiments, the method 500 further may include a step 504 of transmitting, using the processing device 604, the question data to two or more user devices. Further, in some embodiments, the method 500 further may include a step 506 of receiving, using the communication device 602, the reference data. Further, the reference data may be received in response to the question data.

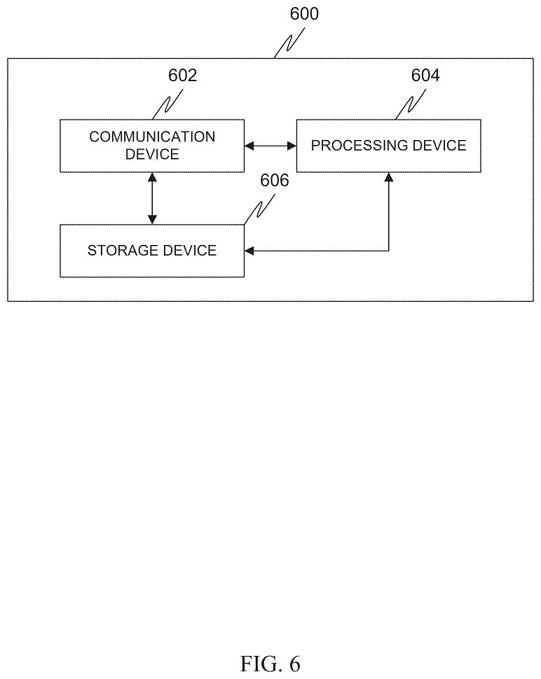

FIG. 6 illustrates a block diagram of a system 600 of facilitating provisioning of a verification data, in accordance with some embodiments.

Accordingly, the system 600 may include a communication device 602. Further, the communication device 602 may be configured to receive a digital content data from one or more of a content provider device associated with a content provider and a user device. Further, the communication device 602 may be configured to transmit validity data, and an association indicator to one or more of the content provider device and the user device. Further, the association indicator represents an association between the validity data and a claimed data. Further, the system 600 may include a processing device 604 communicatively coupled with the communication device 602. Further, the processing device 604 may be configured to analyze the digital content data. Further, the processing device 604 may be configured to identify the claimed data associated with the digital content data based on the analyzing. Further, the processing device 604 may be configured to generate a query based on the claimed data. Further, the processing device 604 may be configured to analyze the claimed data, and reference data. Further, the processing device 604 may be configured to generate the validity data based on the analyzing. Further, the validity data indicates an authenticity of the claimed data based on the reference data. Further, the system 600 may include a storage device 606 communicatively coupled with each of the communication device 602 and the processing device 604. Further, the storage device 606 may be configured to retrieve the reference data. Further, the retrieving of the reference data may be based on the query.

In some embodiments, the analyzing of the digital content data may be based on a first machine learning model. Further, the first machine learning model may be trained on a natural language processing algorithm. Further, the first machine learning model may be configured to receive the digital content data as input. Further, the first machine learning model may be configured to recognize a pattern associated with the digital content data based on the training. Further, the first machine learning model may be configured to identify the claimed data based on recognizing of the pattern.

In some embodiments, the reference data may be stored in a hierarchical data structure comprising of two or more reference data. Further, each of the two or more reference data includes index data which may be configured to allow accessing of a corresponding reference data within the hierarchical data structure.

In some embodiments, the digital content data includes a visual data. Further, the analyzing of the digital content data may be based on an image processing model. Further, the method further includes generating, using the processing device 604, text data based on the analyzing. Further, the identification of the claimed data may be further based on the text data.

In some embodiments, the digital content data includes audio data. Further, the analyzing of the digital content data may be based on an audio processing model. Further, the method further includes generating, using the processing device 604, an audio extracted data based on the analyzing. Further, the identification of the claimed data may be further based on the audio extracted data.

In some embodiments, the processing device 604 may be further configured to generate a user interface based on the validity data. Further, the user interface may be configured to present the validity data as an annotation corresponding to the claimed data. Further, the communication device 602 may be further configured to transmit the user interface to one or more of a content provider device and the user device.

In some embodiments, the analyzing of the claimed data and the reference data may be based on a second machine learning model. Further, the second machine learning model may be trained on a natural language processing algorithm. Further, the second machine learning model may be configured to receive the claimed data and the reference data as input. Further, the machine learning model may be configured to determine one or more of a similarity data, a dissimilarity data, a context data, and a verdict data. Further, the generation of the validity data may be based on the determination of the one or more of the similarity data, the dissimilarity data, the context data, and the verdict data.

In some embodiments, the reference data includes two or more reference data. Further, the method further includes generating, using a processing device 604, two or more results. Further, each of the two or more results may be associated with a factual accuracy of the digital content data based on each of the two or more reference data. Further, the validity data may be generated based on the two or more initial fact checks.

In some embodiments, the communication device 602 may be further configured to communicate with the user device comprising of a user processing device, a user communication device, and a user device sensor. Further, the user device sensor may be configured to generate sensor data. Further, the user communication device may be configured to transmit the digital content data based on the sensor data.

In some embodiments, the processing device 604 may be further configured to generate a question data based on the claimed data. Further, the communication device 602 may be further configured to transmit the question data to two or more user devices. Further, the communication device 602 may be further configured to receive the reference data. Further, the reference data may be received in response to the question data.

According to some embodiments, a method of facilitating provisioning of a verification data is disclosed. Further, the method may include receiving, using a communication device, a digital content data from a data source device. Further, the method may include analyzing, using a processing device, the digital content data. Further, the method may include identifying, using the processing device, the claimed data based on the analyzing. Further, the method may include generating, using the processing device, a query based on the claimed data. Further, the method may include executing, using the processing device, the query. Further, the method may include retrieving, using a storage device, a reference data based on the execution of the query. Further, the method may include analyzing, using the processing device, the reference data, and the claimed data. Further, the method may include generating, using the processing device, a validity data based on the analyzing. Further, the validity data indicates an authenticity of the claimed data based on the reference data. Further, the method may include transmitting, using the communication device, the digital content data to a user device. Further, the transmitting may be based on the validity data.

In some embodiments, the analyzing of the digital content data may be based on a first machine learning model. Further, the first machine learning model may be trained on a natural language processing algorithm. Further, the first machine learning model may be configured to receive the digital content data as input. Further, the first machine learning model may be configured recognize a pattern associated with the digital content data based on the training. Further, the first machine learning model may be configured to identify the claimed data based on recognizing of the pattern.

In some embodiments, the reference data may be stored in a hierarchical data structure comprising of two or more reference data. Further, each of the two or more reference data includes an index data which may be configured to allow accessing of a corresponding reference data within the hierarchical data structure.

In some embodiments, the digital content data includes a visual data. Further, the analyzing of the digital content data may be based on an image processing model. Further, the method further includes generating, using the processing device, a text data based on the analyzing. Further, the identification of the claimed data may be further based on the text data.

In some embodiments, the digital content data includes an audio data. Further, the analyzing of the digital content data may be based on an audio processing model. Further, the method further includes generating, using the processing device, an audio extracted data based on the analyzing. Further, the identification of the claimed data may be further based on the audio extracted data.

Further, in some embodiments, the method further may include generating, using the processing device, a user interface based on the validity data. Further, the user interface may be configured to present the validity data as an annotation corresponding to the claimed data. Further, in some embodiments, the method further may include transmitting, using the communication device, the user interface to one or more of a content provider device and the user device.

In some embodiments, the analyzing of the claimed data and the reference data may be based on a second machine learning model. Further, the second machine learning model may be trained on a natural language processing algorithm. Further, the second machine learning model may be configured to receive the claimed data and the reference data as input. Further, the machine learning model may be configured to determine one or more of a similarity data, a dissimilarity data, a context data, and a verdict data. Further, the generation of the validity data may be based on the determination of the one or more of the similarity data, the dissimilarity data, the context data, and the verdict data.

In some embodiments, the reference data includes two or more reference data. Further, the method further includes generating, using a processing device, two or more results. Further, each of the two or more results may be associated with a factual accuracy of the digital content data based on each of the two or more reference data. Further, the validity data may be generated based on the two or more initial fact checks.

In some embodiments, the method may further include communicating, using the communication device, with the user device comprising of a user processing device, a user communication device, and a user device sensor. Further, the user device sensor may be configured to generate a sensor data. Further, the user communication device may be configured to transmit the digital content data based on the sensor data.

Further, in some embodiments, the method further may include generating, using the processing device, a question data based on the claimed data. Further, in some embodiments, the method further may include transmitting, using the processing device, the question data to two or more user devices. Further, in some embodiments, the method further may include receiving, using the communication device, the reference data. Further, the reference data may be received in response to the question data.

Although the invention has been explained in relation to its preferred embodiment, it is to be understood that many other possible modifications and variations can be made without departing from the spirit and scope of the invention as hereinafter claimed.

What is claimed is:

1. A method of facilitating provisioning of a verification data, the method comprising:
receiving, using a communication device, a digital content data from at least one of a content provider device associated with a content provider and a user device;
analyzing, using a processing device, the digital content data;
identifying, using the processing device, a claimed data associated with the digital content data based on the analyzing;
generating, using the processing device, a query based on the claimed data;
retrieving, using a storage device, a reference data, wherein the retrieving of the reference data is based on the query;
analyzing, using the processing device, the claimed data, and the reference data;
generating, using the processing device, a validity data based on the analyzing, wherein the validity data indicates an authenticity of the claimed data based on the reference data; and
transmitting, using the communication device, the validity data, and an association indicator to at least one of the content provider device and the user device, wherein the association indicator represents association between the validity data and the claimed data.

2. The method of claim 1, wherein the analyzing of the digital content data is based on a first machine learning model, wherein the first machine learning model is trained on a natural language processing algorithm, wherein the first machine learning model is configured to receive the digital content data as input, wherein the first machine learning model is configured recognize a pattern associated with the digital content data based on the training, wherein the first machine learning model is configured to identify the claimed data based on recognizing of the pattern.

3. The method of claim 1, wherein the reference data is stored in a hierarchical data structure comprising of a plurality of reference data, wherein each of the plurality of reference data comprises an index data configured to allow accessing of a corresponding reference data within the hierarchical data structure.

4. The method of claim 1, wherein the digital content data comprises a visual data, wherein the analyzing of the digital content data is based on an image processing model, wherein the method further comprises generating, using the processing device, a text data based on the analyzing, wherein the identification of the claimed data is further based on the text data.

5. The method of claim 1, wherein the digital content data comprises an audio data, wherein the analyzing of the digital content data is based on an audio processing model, wherein the method further comprises generating, using the processing device, an audio extracted data based on the analyzing, wherein the identification of the claimed data is further based on the audio extracted data.

6. The method of claim 1 further comprising:
generating, using the processing device, a user interface based on the validity data, wherein the user interface is configured to present the validity data as an annotation corresponding to the claimed data; and
transmitting, using the communication device, the user interface to at least one of a content provider device and the user device.

7. The method of claim 1, wherein the analyzing of the claimed data and the reference data is based on a second machine learning model, wherein the second machine learning model is trained on a natural language processing algorithm, wherein the second machine learning model is configured to receive the claimed data and the reference data as input, wherein the machine learning model is configured to determine one or more of a similarity data, a dissimilarity data, a context data, and a verdict data, wherein the generation of the validity data is based on the determination of the one or more of the similarity data, the dissimilarity data, the context data, and the verdict data.

8. The method of claim 1, wherein the reference data comprises a plurality of reference data, wherein the method further comprises generating, using a processing device, a plurality of results, wherein each of the plurality of results is associated with a factual accuracy of the digital content data based on each of the plurality of reference data, wherein the validity data is generated based on the plurality of initial fact checks.

9. The method of claim 1 further comprising communicating, using the communication device, with the user device comprising of a user processing device, a user communication device, and a user device sensor, wherein the user device sensor is configured to generate a sensor data, wherein the user communication device is configured to transmit the digital content data based on the sensor data.

10. The method of claim 1 further comprising:
generating, using the processing device, a question data based on the claimed data;
transmitting, using the processing device, the question data to a plurality of user devices;
receiving, using the communication device, the reference data, wherein the reference data is received in response to the question data.

11. A system for facilitating provisioning of a verification data, the system comprising:
a communication device configured to:
receive a digital content data from at least one of a content provider device associated with a content provider and a user device;
transmit a validity data, and an association indicator to at least one of the content provider device and the user device, wherein the association indicator represents association between the validity data and a claimed data;
a processing device communicatively coupled with the communication device, wherein the processing device is configured to:
analyze the digital content data;
identify the claimed data associated with the digital content data based on the analyzing;
generate a query based on the claimed data;
analyze the claimed data, and a reference data;
generate the validity data based on the analyzing, wherein the validity data indicates an authenticity of the claimed data based on the reference data; and
a storage device communicatively coupled with each of the communication device and the processing device, wherein the storage device is configured to:
retrieve the reference data, wherein the retrieving of the reference data is based on the query.

12. The system of claim 11, wherein the analyzing of the digital content data is based on a first machine learning model, wherein the first machine learning model is trained on a natural language processing algorithm, wherein the first machine learning model is configured to receive the digital content data as input, wherein the first machine learning model is configured recognize a pattern associated with the digital content data based on the training, wherein the first machine learning model is configured to identify the claimed data based on recognizing of the pattern.

13. The system of claim 11, wherein the reference data is stored in a hierarchical data structure comprising of a plurality of reference data, wherein each of the plurality of reference data comprises an index data configured to allow accessing of a corresponding reference data within the hierarchical data structure.

14. The system of claim 11, wherein the digital content data comprises a visual data, wherein the analyzing of the digital content data is based on an image processing model, wherein the method further comprises generating, using the processing device, a text data based on the analyzing, wherein the identification of the claimed data is further based on the text data.

15. The system of claim 11, wherein the digital content data comprises an audio data, wherein the analyzing of the digital content data is based on an audio processing model, wherein the method further comprises generating, using the processing device, an audio extracted data based on the analyzing, wherein the identification of the claimed data is further based on the audio extracted data.

16. The system of claim 11, wherein the processing device is further configured to generate a user interface based on the validity data, wherein the user interface is configured to present the validity data as an annotation corresponding to the claimed data, wherein the communication device is further configured to transmit the user interface to at least one of a content provider device and the user device.

17. The system of claim 11, wherein the analyzing of the claimed data and the reference data is based on a second machine learning model, wherein the second machine learning model is trained on a natural language processing algorithm, wherein the second machine learning model is configured to receive the claimed data and the reference data as input, wherein the machine learning model is configured to determine one or more of a similarity data, a dissimilarity data, a context data, and a verdict data, wherein the generation of the validity data is based on the determination of the one or more of the similarity data, the dissimilarity data, the context data, and the verdict data.

18. The system of claim 11, wherein the reference data comprises a plurality of reference data, wherein the method further comprises generating, using a processing device, a plurality of results, wherein each of the plurality of results is associated with a factual accuracy of the digital content data based on each of the plurality of reference data, wherein the validity data is generated based on the plurality of initial fact checks.

19. The system of claim 11, wherein the communication device is further configured to communicate with the user device comprising of a user processing device, a user communication device, and a user device sensor, wherein the user device sensor is configured to generate a sensor data, wherein the user communication device is configured to transmit the digital content data based on the sensor data.

20. The system of claim 11, wherein the processing device is further configured to generate a question data based on the claimed data, wherein the communication device is further configured to transmit the question data to a plurality of user devices, wherein the communication device is further configured to receive the reference data, wherein the reference data is received in response to the question data.
